(19) United States
(12) Patent Application Publication
(10) Pub. No.: US 2014/0064171 A1
(43) Pub. Date: Mar. 6, 2014

(54) METHOD FOR CONSERVING POWER ON BATTERY-POWERED COMMUNICATION DEVICES

(71) Applicant: College of William Mary, Williamsburg, VA (US)

(72) Inventors: Gang Zhou, Williamsburg, VA (US); Andrew J. Pyles, Williamsburg, VA (US); Xin Qi, Williamsburg, VA (US)

(73) Assignee: College of William and Mary, Willamsburg, VA (US)

(21) Appl. No.: 14/016,635

(22) Filed: Sep. 3, 2013

Related U.S. Application Data
(60) Provisional application No. 61/696,474, filed on Sep. 4, 2012.

(51) Int. Cl. H04W 52/02

(52) U.S. Cl. CPC H04W 52/0225
USPC 370/311

(57) ABSTRACT

A method limits power usage by a battery-powered communication device having high and low power states of operation. The device's WiFi driver running on a kernel level of the operating system includes a counter-based routine for placing the device in one of its low power state and high power state. A high or low priority level is established for applications maintained on the device. An identifier for each application and its priority level is stored within a module maintained at the operating system's kernel level. Network traffic passing through the kernel level is monitored to determine whether the network traffic is associated with one of the identified applications and whether the priority level associated therewith is high priority. The counter-based routine of the WiFi driver is accessed when the network traffic is associated with one of the applications and its priority level is high priority.

### CROSS-REFERENCE TO RELATED APPLICATIONS

Pursuant to 35 U.S.C. §119, the benefit of priority from provisional application 61/696,474, with a filing date of Sep. 4, 2012, is claimed for this non-provisional application.

### STATEMENT REGARDING FEDERALLY SPONSORED RESEARCH OR DEVELOPMENT

Not applicable

### FIELD OF INVENTION

The present application relates to methods for limiting power usage on battery-powered communication devices such as smartphones.

### BACKGROUND OF THE INVENTION

Battery-powered communication devices (e.g., cell phones, smartphones, laptop computers, pad computers, etc.) are widely used to access the wireless communication system. In terms of battery power requirements, communication devices use less battery power when accessing a cellular data network than when accessing one of the wireless network transport media. However, wireless network transport media provide (i) faster data transfer rates than cellular data networks, (ii) lower cost of usage since the airtime charges associated with cellular data networks do not typically apply, and (iii) lower latency compared to cellular data networks.

The majority of battery-powered communication devices using a wireless network transport media can be classified as smartphones. As much as one-third of a smartphone's battery energy is consumed by its interface that accesses a wireless network transport media. That is, when this interface is “on” (i.e., fully powered in the case of 2G/3G/4G) or “awake” (i.e., powered to support the device's Constantly Awake Mode (CAM) in the case of wireless fidelity or “WiFi”), the power requirements are substantially greater (e.g., by a factor of about 20) than when this interface is “off” (i.e., no power in the case of 2G/3G/4G) or “asleep” (i.e., minimally powered to support the device's Power Save Mode (PSM) in the case of WiFi). PSM consumes little power at the cost of added latency of up to 300 ms. Latency can cause performance issues for interactive applications such as web browsers and real-time “voice over internet protocol” (VoIP) applications. In contrast, CAM consumes high power but delivers high performance and low latency. Accordingly, battery power for a communication device can be conserved by limiting use of the “on” or CAM state to those applications requiring high performance. However, recent estimates suggest that 65-75% of energy consumed by free smartphone apps is spent on “unimportant” traffic to include downloading ads and uploading user tracking information.

### BRIEF SUMMARY OF THE INVENTION

Accordingly, it is an object of the present invention to provide a method of limiting power usage by a battery-powered communication device that communicates over a wireless network transport media.

Another object of the present invention is to provide a method of conserving battery power by limiting a battery-powered communication device's operation in a Constantly Awake Mode of power usage to certain applications.

In accordance with the present invention, a method of limiting power usage by a battery-powered communication device capable of communicating over a wireless network transport media is provided. The communication device has a high power state of operation and a low power state of operation wherein battery power required for the low power state of operation is less than battery power required for the high powered state of operation. The communication device also has a wireless fidelity (WiFi) driver running on a kernel level of the communication device's operating system. The WiFi driver includes a counter-based routine for placing the communication device in one of its low power state and high power state. A priority level is established for applications maintained on the communication device. Specifically, the priority level is one of high priority and low priority. An identifier for each application and its priority level is stored within a module maintained at the operating system's kernel level. Network traffic passing through the kernel level is monitored to determine whether the network traffic is associated with one of the identified applications and whether the priority level associated therewith is high priority. The counter-based routine of the WiFi driver is accessed when the network traffic is associated with one of the applications and its priority level is high priority.

### BRIEF DESCRIPTION OF THE DRAWINGS

The summary above, and the following detailed description, will be better understood in view of the drawings that depict details of preferred embodiments.

FIG. 1 is a schematic view of a battery-powered communication device to include a flow chart showing the steps involved in an implementation of a WiFi Manager running on the device's WiFi Driver in accordance with conventional art;

FIG. 2 is a schematic view of a battery-powered communication device modified to limit high power usage by the device to just high priority applications in accordance with an embodiment of the present invention;

FIG. 3 is a schematic view of a battery-powered communication device modified to limit high power usage by the device to high priority applications and certain low priority applications in accordance with another embodiment of the present invention;

FIG. 4 is a schematic view of a battery-powered communication device modified to monitor network traffic in order to designate a priority level for the traffic and then limit high power usage by the device based on the designated priority level in accordance with another embodiment of the present invention; and

FIG. 5 is a schematic view of a battery-powered communication device modified to limit high power usage by the device while also accepting user-supplied changes of an application's priority level in accordance with another embodiment of the present invention.

### DETAILED DESCRIPTION OF THE INVENTION

Before describing exemplary embodiments of the present invention, it will be useful to describe and define the terms “communication device,” “wireless network transport media” and “network traffic” as they will be referred to herein in order to illustrate the scope of the present invention. The term “communication device” refers to any phone, smartphone, personal computer, laptop computer, video game console, or other device that can connect to the internet using a wireless network transport media and support network traffic. The term “wireless network transport media” refers to any of a range of technologies that can provide a communication device with access to the internet in a wireless fashion. Examples of well-known wireless network media include those based on the Institute of Electrical and Electronic Engineers (IEEE) 802.11 wireless fidelity standards (more commonly referred to by the trademark “WiFi” or derivative terms thereof). Other examples of wireless network transport media include the multiple generations (i.e., “2G,” “3G,” “4G,” etc.) based on the standards/specifications set forth by the International Telecommunications Union in the International Mobile Telecommunications (IMT)-2000 (or IMT-2000 as it is known). The term “network traffic” refers to any packets of information received by the communication device over the wireless network transport media and any outgoing packets of information generated by the communication device for transmission over the wireless network transport media. Such network traffic includes interactive communication associated with an application, received/downloaded communication associated with an application and/or unrelated to the application, and background communication unrelated to any particular application.

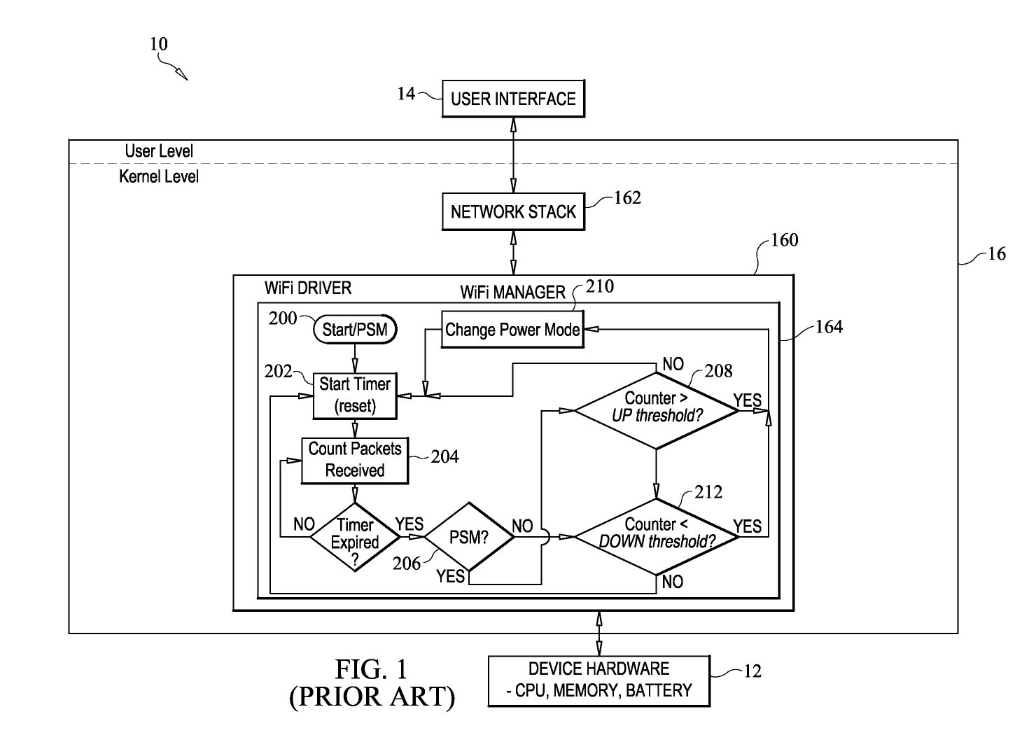

Before describing the present invention, it will be useful to describe a conventional approach to switching a communication device between PSM and CAM states of power usage. To aid in this description, reference will be made to FIG. 1 where a battery-powered communication device is shown schematically and is referenced generally by numeral 10. It is to be understood that only those portions of device 10 germane to the understanding of switching between PSM and CAM are illustrated. As is known in the art, device 10 includes hardware elements 12, a user interface 14, and an operating system (OS) 16 that is the link between user interface 14 and hardware 12 providing the functionality of device 10. By way of example, OS 16 can be the open-source Android operating system that includes a WiFi driver 160 running on the kernel level of OS 16. A network stack 162 provides the definition of transmission protocols (e.g., TCP/IP) that will be used by OS 16.

In terms of switching device 10 between PSM and CAM, WiFi driver 160 includes a WiFi manager 164 that adaptively switches device 10 between PSM and CAM based on aggregate network traffic in accordance with the steps shown in the flow diagram. Briefly and as is known in the art, WiFi manager 164 is initialized at step 200 to PSM and a start timer is set to one second at step 202. During each one second interval, both incoming and outgoing packets are counted at step 204. At the conclusion of the one second interval, the power usage state is checked at step 206. If device 10 is in PSM, the number of packets counted in the one second interval is compared to an UP threshold at step 208, which, if exceeded, causes device 10 to be switched to CAM at step 210. However, if the number of packets counted in the one second interval does not exceed the UP threshold, device 10 is maintained in PSM and a new time interval is examined. Conversely, if device 10 is in CAM at step 206, the number of packets counted in the one second interval is compared to a DOWN threshold at step 212. If the number of counted packets falls below the DOWN threshold, device 10 is switched back to PSM at step 210.

As discussed previously herein, this aggregate network traffic approach to adaptive PSM allows high volume but unimportant or background traffic to place and maintain device 10 in CAM. The various embodiments of the present invention will eliminate this problem by limiting the times that device 10 is switched and/or maintained in the high-power CAM state. By restricting unimportant/background applications to PSM, the present invention conserves battery power for device 10.

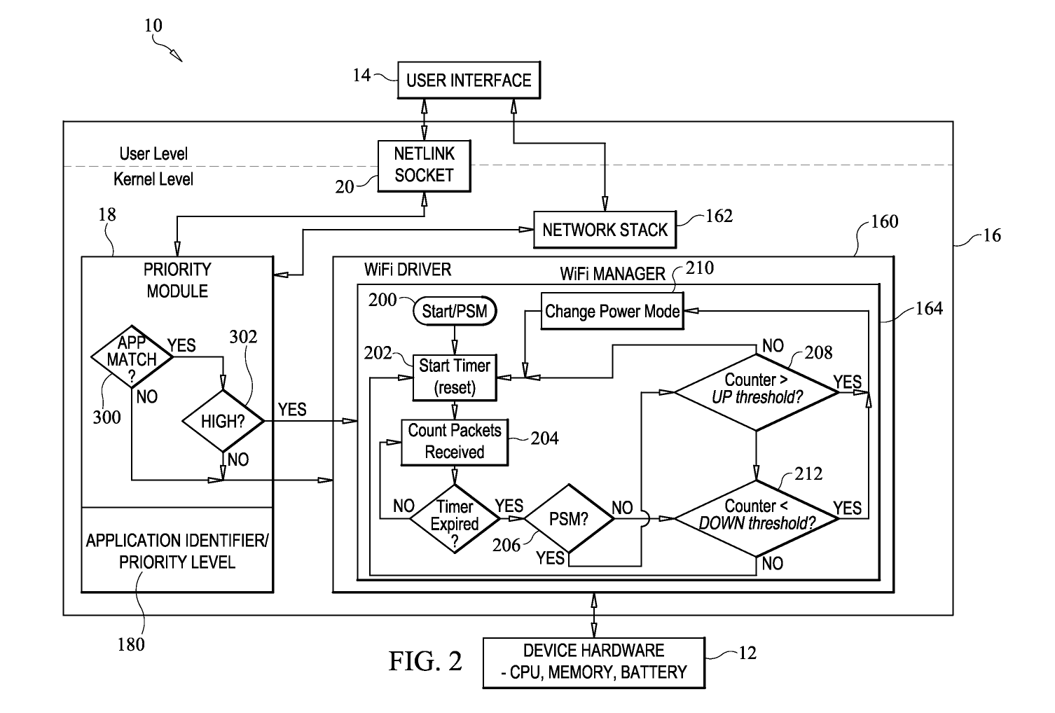

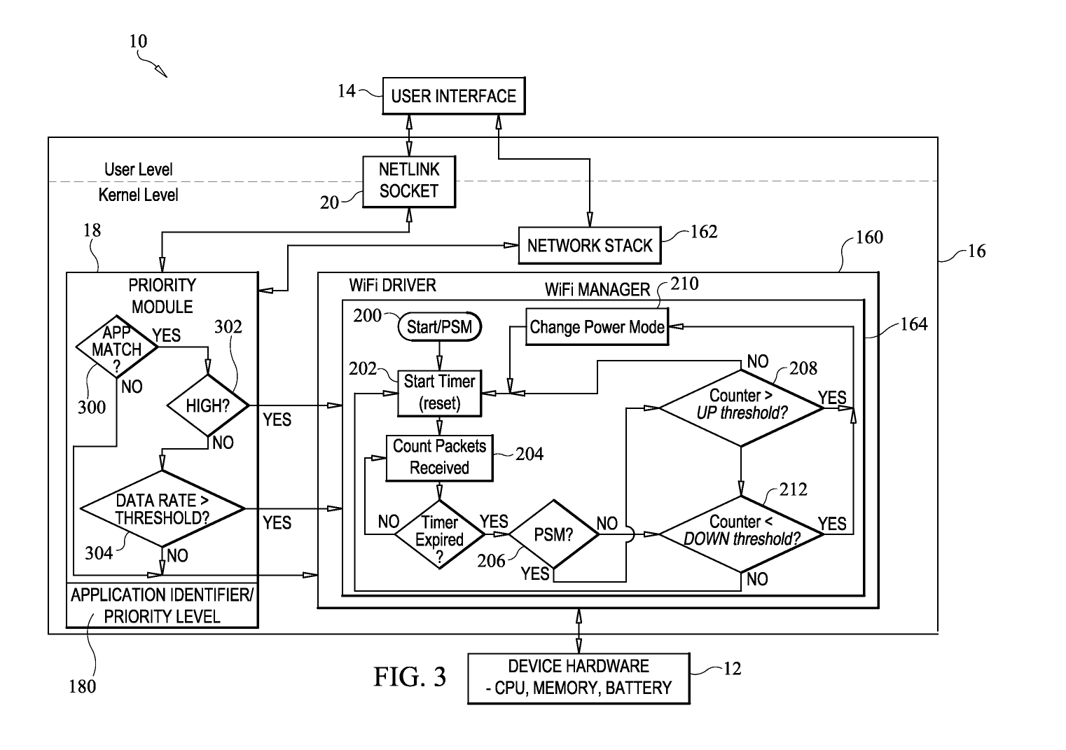

Referring now to FIG. 2, device 10 is modified to limit power usage in accordance with an embodiment of the present invention. Common reference numerals are used for those elements/functions of device 10 already described herein. Briefly, the modifications to device 10 monitor network traffic in terms of a priority level assigned thereto. Two priority levels are possible. That is, each application (or “app”) is tagged with a priority level. When an application's priority level is set to high priority, the application's network traffic is permitted to adaptively switch to CAM by accessing the existing WiFi manager 164 running on WiFi driver 160. A low priority setting for an application means that application's network traffic is not permitted to switch to CAM, but will instead remain in PSM. More specifically, low priority traffic is not processed by WiFi manager 164 such that low priority traffic remains in the default PSM state. Note that some low priority traffic could be more efficiently handled in CAM. For example and as will be explained later below, it was experimentally determined that data rates exceeding 3 Mb/sec while in PSM consume more power than in CAM. Accordingly, another embodiment of the present invention (FIG. 3) can include modifications that allow some low priority applications to access WiFi manager 164 and thereby have the opportunity to switch device 10 to CAM.

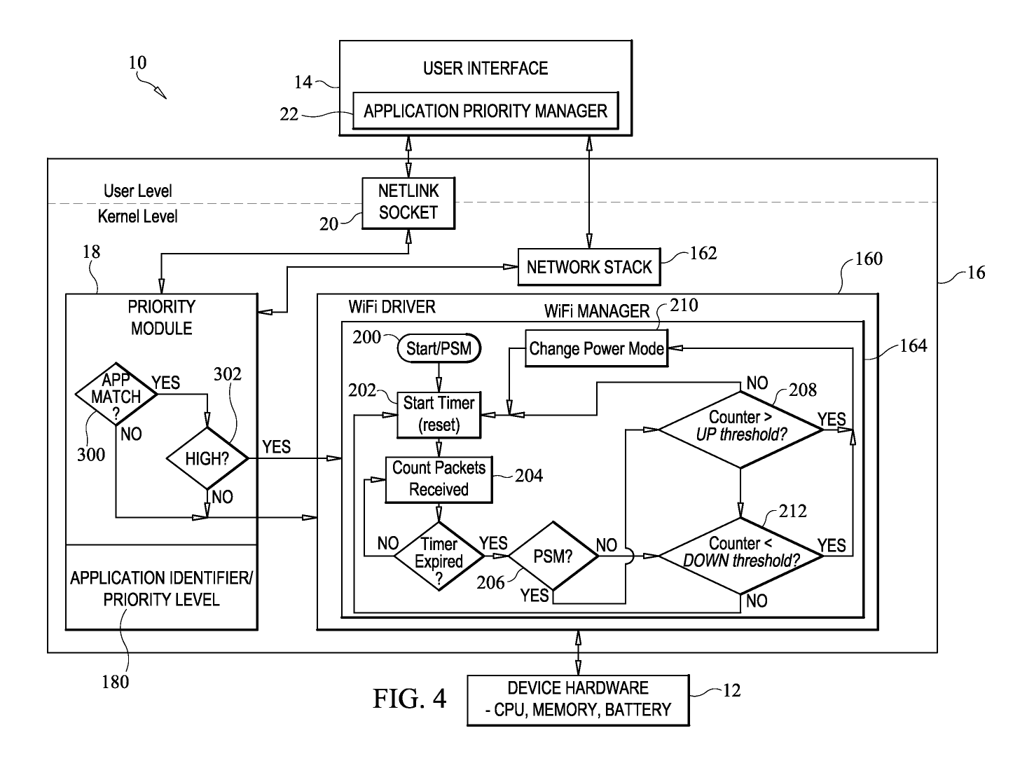

Additionally, the present invention assumes that any traffic not associated with an application is considered low priority to save more energy. The modifications provided by the embodiment illustrated in FIG. 2 interrupt network traffic passing through the kernel level of OS 16. A priority module 18 is a processing module installed at the kernel level of OS 16 that interfaces with WiFi driver 160 and interfaces with user interface 14 via a netlink socket 20. Priority module 18 includes a database 180 storing application identifiers and each application's associated priority level (i.e., high or low priority) installed on device 10. For the illustrated embodiment, it will be assumed that the high/low priority designations are already established/stored in database 180. Establishment of the priority level designation can be predetermined in accordance with a variety of offline schemes, the choice of which is not a limitation of the present invention. However and as will be illustrated in another embodiment (FIG. 4) explained later herein, the present invention can include modifications that designate an application's priority level in an online fashion based on statistics associated with the application's network traffic.

Network traffic (i.e., incoming and outgoing packets) are interrupted by priority module 18 where packet header information will include an application's identifier information. Priority module 18 checks database 180 at a processing step 300 to see if the application identifier associated with the network traffic matches any identifier stored in database 180. If there is a match with an application stored in database 180, the stored priority level associated with that application is checked for a high priority level at processing step 302. If the matched application has a high priority level designation, access to WiFi manager 164 is permitted and the previously-described counter-based routine runs. The switch from PSM to CAM is made provided the high-priority traffic associated with the application warrants the switch. Conversely, if there is no application identifier match at step 300 (i.e., the application is not installed on device 10) or if an installed application is low priority, WiFi manager 164 is not accessed. That is, WiFi manager 164 essentially ignores low-priority network traffic and non-application related network traffic so that all such traffic remains in the default PSM state.

As mentioned above, some applications running in PSM can make more efficient use of power if run in CAM. For example, when data rates exceed approximately 3 Mb/sec, it has been found that the CAM state of power usage is more efficient than the PSM state. Accordingly, FIG. 3 illustrates another embodiment of the present invention that allows WiFi manager 164 to be accessed for certain low priority applications. Specifically, priority module 18 provides a data rate check for low priority applications at processing step 304 to see if a certain threshold (e.g., 3 Mb/sec) is met by the low priority network traffic. If the threshold is met, WiFi manager 164 is accessed for a possible switch to the CAM state as described above. If the data rate threshold is not met for the low priority application, WiFi manager 164 is not accessed.

Either of the previous two embodiments could also include modifications that supported online designation of an application's priority level. By way of example, the embodiment illustrated in FIG. 2 is further modified in FIG. 4 to designate priority for network traffic associated with applications. An application priority manager (APM) 22 can be configured as an application that runs as a background service. In general, APM 22 gathers usage metric/statistics for applications running on device 10. The statistics are used to set/designate a priority level for an application. For example, the collected statistics could be provided to a trained classifier (maintained at APM 22) that designates high priority or low priority based on classifier definitions developed from network traffic statistics. The application's identifier and its designated priority level are then communicated to priority module 18 and stored in database 180. With database 180 established, priority module 18 intercepts network traffic and evaluates the priority thereof as previously described.

APM 22 can be configured to adaptively set priority level of an application without any user intervention. To do this, APM 22 monitors network traffic statistics using a program such as TrafficStats API. TrafficStats API provides the total amount of bytes each application has transmitted and received at a given time. By polling every second (or every few seconds), the data rate can be determined for each application being used. Each individual poll performs a low impact atomic read from the /proc file system which has a low energy consumption.

Through the TrafficStats API, APM 22 collects the following four statistics:

RXBytes: the total received bytes by the WiFi driver;

TXBytes: the total transmitted bytes by WiFi driver;

RXRate: receiving data rate in KBytes/sec; and

TXRate: transmitting data rate in KBytes/sec.

For each application, RXBytes and TXBytes reflect the total traffic while RXRate and TXRate reflect instantaneous traffic. These four statistics together provide information characterizing each application's incoming and outgoing traffic.

With the collected information of each application's WiFi usage, APM 22 can use an offline-trained classifier to classify each application into either high priority or low priority. While this information is being collected, each application is set to low priority by default. This allows users to save energy on newly installed applications during the data gathering phase. If the latency introduced by PSM noticeably places the usability of an application in question, the user could be prompted with the option to manually set the application's priority to high as will be explained further below.

While this application priority designation process could be completely automated, each designation could also be offered for confirmation to the end user as a prompt on user interface 14 since the designation can impact the battery life of the device. Also, such user feedback can eventually be used to train an individualized classifier. If an application is classified as high priority, APM 22 could display a window on user interface 14 and ask the user whether this application should be set to high priority. APM 22 then stores/updates the user's decision in database 180 of priority module 18.

An offline classifier that could be used in APM 22 is the Support Vector Machine (SVM) classifier. Details of SVM classifiers are disclosed by Cristianni et al. in “An Introductions to Support Vector Machines and Other Kernel-based Learning Methods,” Cambridge University Press, 2000. As mentioned above, the classifier differentiates applications into high priority and low priority based on the collected information associated with each application's network traffic. In general, SVM has the following four advantages over other classifiers: (1) the optimization problem involved in SVM is a convex optimization problem, whose local solution is also a global solution; (2) SVM is able to achieve high accuracy with a relatively small number of training examples; (3) SVM scales well with data dimensionality; and (4) SVM is fast to execute at runtime.

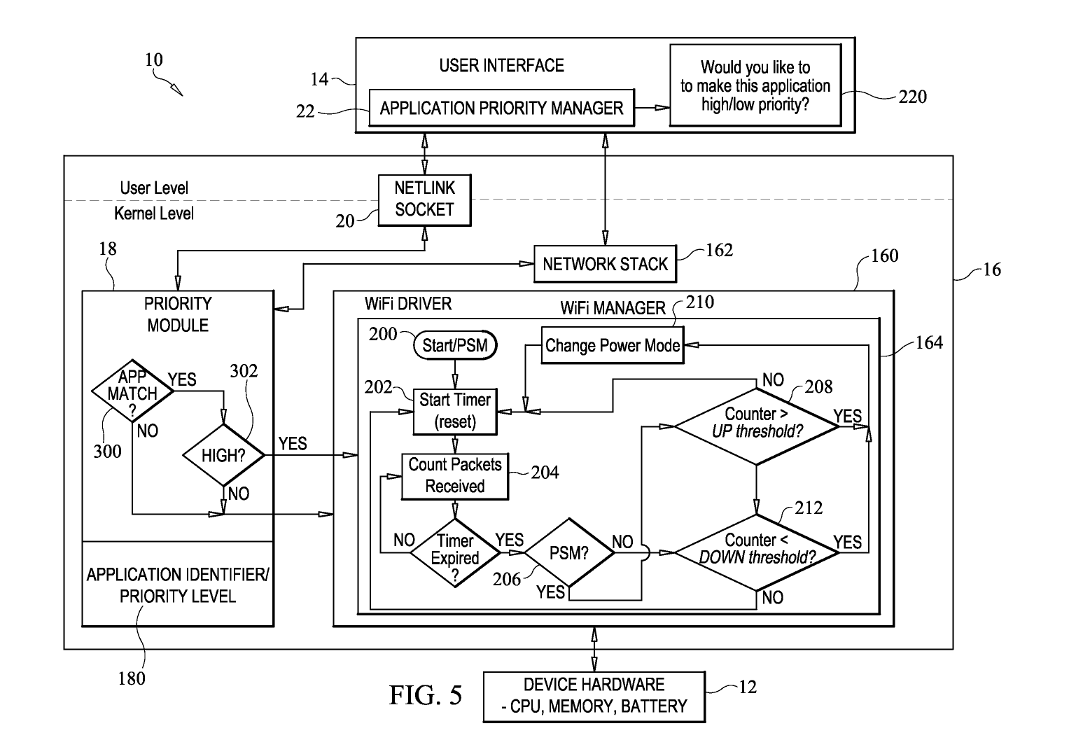

Any of the above described embodiments could also be configured to accept user-supplied changes to an application's priority level. For example, the FIG. 4 embodiment could be modified as shown in FIG. 5 such that APM 22 generates a pop-up window 220 on user interface 14 each time an application was to be designated as high or low priority. The APM-selected designation could be presented to the user in window 220 to allow the user to change the designation. Window 220 could include additional explanation, ramifications associated with making a change, etc., to aid a user in the decision making process. APM 22 could also be configured to only accept changes to low priority or only accept changes to high priority without departing from the scope of the present invention.

Embodiments of the present invention were tested on a Sprint HTC Hero. The phone is equipped with the Texas Instruments TI 1251 WiFi chipset that is capable of 802.11b/g. The WiFi driver is freely available and is part of the Android Linux kernel tree. The Android platform is a natural choice because the source code is freely available. Test embodiments included the present invention's priority module implemented completely at the kernel level and the present invention's APM developed as an Android application.

The priority module of the present invention is implemented as a Linux kernel module and is dependent upon the existing WiFi driver that is also implemented as a kernel module. Android loads and unloads the WiFi driver on demand. The user has the ability to load and unload the module at will. Since the priority module requires access to the WiFi driver's WiFi manager for updates to the traffic counter in certain scenarios, dependency issues can arise if the WiFi driver needs to be unloaded. To address this problem, the priority module can implement unregister functions and export them so that they are available to the WiFi driver. When the WiFi driver is loaded, it registers the WiFi manager function with the module. When the WiFi driver is unloaded, the priority module is notified with the unregister function. The priority module is loaded at boot time to avoid any further dependency problems.

In order for the APM to connect to the netlink socket, raw sockets must be used which requires root access. Since Android applications do not run with root privileges for security reasons, a “netlink manager” system service with root privileges can be used. Briefly, a “netlink manager” listens for packets with a FIFO socket interface and then relays the packet through the netlink socket to the priority module.

The list of high priority applications stored in database 180 can be a linked list that is kept persistent after a system reboot. The APM can maintain an internal list of high priority applications for persistency. In this way, when the system is rebooted, the list is pushed to the priority module through the netlink socket.

Several examples will be described below to help explain the present invention and present test results that illustrate its advantages. The examples that follow are intended in no way to limit the scope of this invention but are provided to illustrate the methods of the present invention. Many other embodiments of this invention will be apparent to one skilled in the art.

### Example 1

### Classifier Training

In order to train a SVM classifier and evaluate whether it is able to provide accurate classification results for different users, a user study was conducted. In this study, a random mixture of fourteen technical and non-technical users participated in the user study. A smartphone had several applications installed with each application set to low priority as a default state which is the default WiFi configuration for each application in the present invention. Each participant in the study was required to use each of six applications for ten minutes. A number of applications were selected that have a diverse array of network behavior. The applications included interactive apps (e.g., Android Market and the Android web browser), as well as apps having a low degree of interactivity (e.g., the Tanks and Turrets game). Social networking applications with ambiguous priority depending on usage were also selected (e.g., Gmail, Facebook and Twitter). These applications are ambiguous because they can be used interactively (i.e., clicking on every link) or run in the background in a non-interactive fashion.

During the user study, each participant was given a set of instructions that they should follow. Each phone was configured with static PSM enabled that adds approximately 100-300 ms of network delay or latency. The degrees of interactivity were varied among all participants' instructions and the participants were asked if they felt the observed latency was acceptable. The answers from participants were used as labels for the applications. If a participant believed the observed latency is unacceptable, this application was labeled as high priority. Otherwise, the application was labeled as low priority, which means that any perceived latency does not impact the users experience with the application.

In the background, the APM collects four statistics (as described previously herein) that measure network traffic for each application. The APM groups the statistics for each application and extracts a set of features: (i) the maximum, mean, median and variance of RXRate and TXRate; (ii) RXBytes, TXBytes, and the ratio of RXBytes/TXBytes. These features measure different statistical characteristics of WiFi usage. Note that the ratio RXBytes/TXBytes can reflect an application's network interactivity much better than non-network features like the touch screen rate. If a user is regularly touching the screen, this does not always mean that network traffic is occurring. For example, video games are very interactive with respect to the user and the screen, but typically non-interactive with respect to the network.

The accuracy of an SVM classifier depends on the input features. In this example, the Sequential Forward Search based feature selection algorithm (see Guyon et al., “An introduction to variable feature selection,” J. Mach. Learn. Res., 3: 1157-1182, March 2003) was used to select the best features. The algorithm returned the maximum and mean of RXRate features as the two optimal features. These two features are meaningful in terms of predicting whether any perceived latency added to a given application by static PSM is noticeable by end-users for two reasons. First, compared to TX related features, RX related features are more important because smartphones are more frequently receivers than producers of information. Second, the maximum of RXRate reflects the participant's experience at the network traffic peak and the mean of RXRate reflects the participant's long-term network experience.

With these two features, the optimal parameters for the SVM classifier were selected from the user study data following the routine of 6-fold cross-validation to avoid overfitting and estimate the runtime accuracy. In each round of cross validation, data is divided into 6 subsets, 5 of which are used for training and the remaining 1 is used for testing, so that the testing data is different from the training data. This process is repeated 6 times and each of the 6 subsets is used exactly once as testing data. The accuracy is the average accuracy over 6 rounds. The parameters with the maximal accuracy during cross-validation were selected for the trained classifier. The high/low priority classification made by the users in the study compared favorably with the high/low priority designation made using the above-described SVM classifier. This was true regardless of the background of the user in the study. Thus, the SVM classifier will allow the APM to assist even non-technical users in configuring application priority.

### Example 2

### Low Priority Application Behavior

In this example, the present invention was evaluated with low priority applications. The behavior of the present invention was compared to static PSM and Adaptive PSM methods. Adaptive PSM switched to CAM for the duration of the test due to the high aggregate traffic levels thereby causing significantly higher power consumption (340% more power was used) compared to power used when the present invention was employed. This is because Adaptive PSM has no way to distinguish unwanted traffic from necessary traffic. This test shows the potential for unnecessary excessive power consumption since traffic not associated with a listening socket was treated as low priority traffic by the present invention thereby saving significantly more energy than Adaptive PSM. The present invention increases overhead by approximately 20% when compared to static PSM due to the listening socket check performed on each packet. Thus, if all applications were low priority, static PSM would be preferred. However, in reality there will almost always be a mix of high priority and low priority applications so that static PSM cannot provide efficient power usage in a real-world sense.

The data rate for which PSM network traffic ultimately consumed more energy than CAM was also determined experimentally. To conduct this test, traffic shaping on a web server was configured. Traffic shaping permits the data rate for files downloaded from the server to be limited accurately. In this example, the data rate was limited to the range from 1 Mbit/s to 8 Mbit/s. Results showed that when the data rate exceeds approximately 3 Mbit/s, a PSM energy inversion occurs as static PSM consumes more energy than Adaptive PSM. For data rates less than this threshold, the energy savings in PSM can be significant.

### Example 3

### Energy Savings of Typical Applications

In this example, the energy use of several typical applications that consume a significant amount of network traffic were evaluated. The selected applications included a streaming audio application that allows users to stream audio over the Internet, an offline map application which downloads in-advance maps of a new area you are traveling to with limited network coverage, and an RSS reader application that retrieves RSS feeds from the Internet and caches them on the SD card. Also included were social networking applications (e.g., e-mail, Facebook and Twitter) running in the background while the device's screen is off.

After each application was installed, the following steps were performed. First, the application was allowed to run for approximately 10 minutes. During this time, the APM gathers each application's network statistics as described earlier herein. Next, the APM classifies these measured results with the classifier trained by the user study data. After running this process for the selected applications, the RSS reader and the offline map applications were correctly classified as low priority, while the streaming audio application was incorrectly classified as high priority but then manually set to low.

Each application's behavior was run using Adaptive PSM and with the present invention using the low priority designations. Energy savings using the present invention ranged from 13% for social networking applications up to 56% energy savings for the RSS reader application. Some specifics are presented below.

The streaming audio (e.g., XiiaLive) application has a wide selection of streaming radio stations where users can play different music styles. The added delay of PSM did not affect the quality of the playback since the application was able to buffer the audio stream. Over a 10 minute time span, the present invention yielded energy savings of 44% when compared to Adaptive PSM. This kind of traffic is clearly low priority as there is no noticeable effect if this traffic runs in CAM or in PSM.

The offline map application (e.g., Map-Droyd) has an extensive collection of free maps that can be downloaded. For this test, a 70 MB map of a U.S. state was downloaded. After running the test several times, the present invention yielded energy savings of 18-22% when compared to Adaptive PSM. Since the data rate was small (approximately 1.5 Mbit/s), the present invention clearly saved more energy at the expense of taking more time. However, since delays of this type are acceptable, the present invention produced preferable energy saving results.

The RSS reader application (e.g., RssDemon) has a default install of 16 feeds dispersed over categories of general interest. These include sports, news, technology and entertainment. Periodically, feeds were updated by retrieving the latest from the Internet. The RSS reader downloaded a number of XML RSS files at the first 3-4 minutes of the update period. At approximately 4.5 minutes, several larger files were downloaded. The WiFi manager's UP threshold was triggered quickly at the beginning and stayed for the duration of the test. The present invention yielded energy savings of 56% when compared to Adaptive PSM in this case.

Social networking applications using push technology are often run in the background. That is, even with the screen off, new data is actively pushed to the applications. This type of application is clearly low priority. The following popular applications were tested: Gmail, Facebook and Twitter. For the test, subscription was made to the Linux kernel mailing list and to a number of popular Twitter feeds. Facebook, which does not use push-based notifications, was set to update every 30 minutes. During a one-hour test period, a total of 12 tweets and 30 emails were received while no Facebook activity was observed. Even though the data rate during this test was quite low, it was high enough to switch the device to CAM at several occasions when the device was running on Adaptive PSM. However, when the device ran using the present invention, the device stayed in PSM the entire time. Even with such light traffic, the present invention yielded energy savings of 13% when compared to Adaptive PSM.

### Example 4

### High Priority Networking Performance

While saving energy is important, having solid networking performance for high priority traffic is also important. Accordingly, the present invention was also evaluated in terms of performance. The readily-available networking benchmark called Netperf (http://www.netperr.org) was used to evaluate the performance of the present invention. The Netperf test was repeated 10 times and showed that the present invention only incurred a 3% general networking performance penalty when compared to Adaptive PSM.

The advantages of the present invention are numerous. Existing communication devices can be readily modified via the addition of a kernel level module to limit power usage by low-priority or non-application-related network traffic. Priority level descriptions can be established offline or online. The processing can be completely automated or could provide for the acceptance of user-supplied changes to a priority level designation.

### INCORPORATION BY REFERENCE

All publications, patents, and patent applications cited herein are hereby expressly incorporated by reference in their entirety and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

The articles “a” and “an” are used herein to refer to one or to more than one (i.e. to at least one) of the grammatical object of the article. By way of example, “an application” means one application or more than one application.

Any ranges cited herein are inclusive, e.g., “between five percent and seventy-five percent” includes percentages of 5% and 75%.

We claim:

1. A method of limiting power usage by a battery-powered communication device capable of communicating over a wireless network transport media, comprising the steps of:
providing a battery-powered communication device capable of accessing a wireless network transport media, the communication device having a high power state of operation and a low power state of operation wherein battery power required for said low power state of operation is less than battery power required for said high powered state of operation, the communication device having a wireless fidelity (WiFi) driver running on a kernel level of the communication device's operating system, said WiFi driver including a counter-based routine for placing the communication device in one of said low power state and said high power state;
establishing a priority level for applications maintained on the communication device, said priority level being one of high priority and low priority;
storing an identifier for each of said applications and said priority level associated therewith within a module maintained at said kernel level;
monitoring network traffic passing through said kernel level to determine whether said network traffic is associated with one of said applications and whether said priority level associated therewith is said high priority; and
accessing said counter-based routine of said WiFi driver when said network traffic is associated with one of said applications and said priority level associated therewith is said high priority.

2. A method according to claim 1, further comprising the step of accessing said counter-based routine of said WiFi driver when (i) said network traffic is associated with one of said applications, (ii) said priority level associated therewith is said low priority, and (iii) a data rate of said network traffic exceeds a threshold data rate.

3. A method according to claim 2, wherein said threshold data rate is approximately 3 megabits per second.

4. A method according to claim 1, wherein said step of establishing comprises the step of predetermining said priority level for each of said applications prior to installation thereof on the communication device.

5. A method according to claim 1, wherein said step of establishing includes the steps of:
monitoring statistics associated with said network traffic; and
designating said priority level for each of said applications as being one of high priority and low priority based on said statistics.

6. A method according to claim 1, wherein said step of establishing includes the step of accepting changes to said priority level by a user of the communication device.

7. A method according to claim 1, wherein the communication device is a smartphone.

8. A method according to claim 1, wherein the communication device runs on an Android operating system.

9. A method of limiting operation in a Constantly Awake Mode of power usage by a battery-powered communication device capable of communicating over a wireless network transport media, comprising the steps of:
providing a battery-powered communication device capable of accessing a wireless network transport media, the communication device having a wireless fidelity (WiFi) driver running on a kernel level of the communication device's operating system, said WiFi driver including a counter-based routine for placing the communication device in one of a Constantly Awake Mode of power usage and a Power Save Mode of power usage wherein said WiFi driver defaults to said Power Save Mode of power usage;
establishing a priority level for applications maintained on the communication device, said priority level being one of high priority and low priority;
storing an identifier for each of said applications and said priority level associated therewith within a module maintained at said kernel level;
monitoring, within said module, network traffic passing through said kernel level to determine whether said network traffic is associated with one of said applications and whether said priority level associated therewith is said high priority; and
accessing said counter-based routine of said WiFi driver when said network traffic is associated with one of said applications and said priority level associated therewith is said high priority wherein placing the communication device in said Constantly Awake Mode of power usage is controlled by said counter-based routine.

10. A method according to claim 9, further comprising the step of accessing said counter-based routine of said WiFi driver when said network traffic is associated with one of said applications, said priority level associated therewith is said low priority, and a data rate of said network traffic exceeds a threshold data rate.

11. A method according to claim 10, wherein said threshold data rate is approximately 3 megabits per second.

12. A method according to claim 9, wherein said step of establishing comprises the step of predetermining said priority level for each of said applications prior to an installation thereof on the communication device.

13. A method according to claim 9, wherein said step of establishing includes the steps of:
monitoring statistics associated with said network traffic; and
designating said priority level for each of said applications as being one of high priority and low priority based on said statistics.

14. A method according to claim 9, wherein said step of establishing includes the step of accepting changes to said priority level by a user of the communication device.

15. A method according to claim 9, wherein the communication device is a smartphone.

16. A method according to claim 9, wherein the communication device runs on an Android operating system.

17. A method of limiting power usage by a battery-powered communication device capable of communicating over a wireless network transport media, comprising the steps of:
providing a battery-powered communication device capable of accessing a wireless network transport media, the communication device having a high power state of operation and a low power state of operation wherein battery power required for said low power state of operation is less than battery power required for said high powered state of operation, the communication device having a wireless fidelity (WiFi) driver running on a kernel level of the communication device's operating system, said WiFi driver including a counter-based routine for placing the communication device in one of said low power state and said high power state;
establishing a priority level for applications maintained on the communication device, said priority level being one of high priority and low priority;
storing an identifier for each of said applications and said priority level associated therewith within a module maintained at said kernel level;
monitoring network traffic passing through said kernel level to determine whether said network traffic is associated with one of said applications and whether said priority level associated therewith is said high priority; and
accessing said counter-based routine of said WiFi driver only when one of two conditions is satisfied, wherein a first of said two conditions is defined as said network traffic being associated with one of said applications and said priority level associated therewith is said high priority, and wherein a second of said two conditions is defined as said network traffic being associated with one of said applications while said priority level associated therewith is said low priority and a data rate of said network traffic exceeds a threshold data rate.

18. A method according to claim 17, wherein said threshold data rate is approximately 3 megabits per second.

19. A method according to claim 17, wherein said step of establishing comprises the step of predetermining said priority level for each of said applications prior to installation thereof on the communication device.

20. A method according to claim 17, wherein said step of establishing includes the steps of:
monitoring statistics associated with said network traffic; and
designating said priority level for each of said applications as being one of high priority and low priority based on said statistics.

21. A method according to claim 17, wherein said step of establishing includes the step of accepting changes to said priority level by a user of the communication device.

22. A method according to claim 17, wherein the communication device is a smartphone.

23. A method according to claim 17, wherein the communication device runs on an Android operating system.
